(19) United States
(12) Patent Application Publication
(10) Pub. No.: US 2009/0181745 A1
(43) Pub. Date: Jul. 16, 2009

(54) GAMING MACHINE PROVIDING BONUS BASED ON SPECIAL BET AND PLAYING METHOD THEREOF

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/062,868

(22) Filed: Apr. 4, 2008

Related U.S. Application Data
(60) Provisional application No. 61/020,798, filed on Jan. 14, 2008.

(51) Int. Cl. A63F 13/00

(52) U.S. Cl. 463/17; 463/25

(57) ABSTRACT

When a bet having a bonus chance is performed and a winning is made, a payout that is awarded to a player is smaller, as compared to a case where a base bet it performed and a winning is made. However, a bonus chance having a possibility that a bonus payout will be awarded to the player is executed.

### CROSS REFERENCE TO RELATED APPLICATION

This non-provisional application claims priority from a provisional application No. 61/020,798, filed on Jan. 14, 2008, the entire disclosure of which is herein incorporated by reference.

### BACKGROUND OF THE INVENTION

1. Field of the Invention

The invention relates to a gaming machine that provides a bonus when a player wins a game in a special bet and a playing method thereof.

2. Description of Related Art

In a gaming machine such as a wheel gaming machine referred to as a wheel of fortune (or big-six, money wheel) in which a win mark is predicted and a game is executed, many areas having attached marks (for example, “1,” “2,” “5,” “10,” “20” and two types of star marks) on a wheel are formed and the wheel is rotated and automatically stopped, so that any one area is specified and a win mark is thus determined.

In the above gaming machine, for example as disclosed in U.S. Pat. No. 7,278,635B2, scores are accumulated in each of the gaming machines, and when a player achieves a predetermined condition in any gaming machine, a prize based on the accumulated scores is awarded to the player, as a bonus payout.

As a method of providing the bonus to a player, there are methods of receiving a bet for a bonus, separately from a bet for performing a main game, and setting some of the game values consumed in each gaming machine as a bonus payout.

However, when a bet for a bonus is received, a player plays a game not relating to a main game, at the same time. Due to this, a player may lose an interest in a main game.

In addition, when some of the game values consumed in each gaming machine are set as a bonus payout, the earnings of a game arcade such as casino that provides a game are decreased.

An object of the invention is to provide a gaming machine having an entertainment characteristic, which is not provided to the prior art, and a playing method thereof.

Another object of the invention is to provide a gaming machine capable of providing a bonus suppressing the decrease in the earnings of a game arcade while a player does not an interest in a main game, and a playing method thereof.

### SUMMARY OF THE INVENTION

The invention provides a gaming machine including: a specific mark determining device that determines one of a plurality of marks as a specific mark; a display that displays a plurality of bet areas each of which corresponds to at least one mark and on each of which a game value is bet; an input device that receives, as a bet operation, a base operation and a special operation of betting the game value on any one bet area from the outside; a bonus determining device that randomly determines whether to award a bonus payout or not; and a controller programmed to operate as described in the steps of (a1) to (a6). Specifically, the controller operates: (a1) to respectively set, as payout rates, a base rate corresponding to the base operation and a special rate corresponding to the special operation and having a rate different from the base rate, for each of the bet areas; (a2) to bet the game value on the bet area corresponding to the bet operation that is received by the input device from the outside; (a3) to enable the specific mark determining device to determine the specific mark; (a4) when the specific mark and the bet area on which the game value is bet have a corresponding relation, to award a payout, based on the game value that is bet on the bet area corresponding to the specific mark and the payout rate that is set for the bet area corresponding to the specific mark and corresponds to the bet operation received by the input device from the outside; (a5) when the bet operation received by the input device from the outside is the special operation and the payout is awarded, to enable the bonus determining device to determine whether to award the bonus payout; and (a6) when it is determined that the bonus payout is awarded, to award the bonus payout.

According to the above structure, when a bet area on which a game value is bet and a specific mark have a corresponding relation, a payout is awarded, based on the game value bet and a payout rate corresponding to a bet operation. When the bet operation is a special operation and the payout is awarded, a bonus payout may be awarded. Like this, when a payout is awarded in a main game, there occurs a possibility that a bonus payout will be awarded. Therefore, a player does not lose an interest in the main game. In addition, since a base rate (so-called, odds) that is a payout rate corresponding to a base operation and a special rate that is a payout rate corresponding to a special operation are set to be different, a payout in the main game is low regardless of whether or not a bonus payout is awarded, so that a decrease in the earnings of a game arcade is suppressed. Thereby, a player does not lose an interest in the main game and a bonus is provided which suppresses a decrease in the earnings of a game.

The invention provides a gaming machine including: a wheel device in which a wheel having a plurality of marks disposed thereon is rotated; a display that displays a plurality of bet areas each of which corresponds to at least one mark and on each of which a game value is bet; an input device that receives, as a bet operation, a base operation and a special operation of betting the game value on any one bet area from the outside; and a controller programmed to operate as described in the steps of (b1) to (b6). Specifically, the controller operates: (b1) to respectively set, as payout rates, a base rate corresponding to the base operation and a special rate corresponding to the special operation and having a rate different from the base rate, for each of the bet areas; (b2) to bet the game value on the bet area corresponding to the bet operation that is received by the input device from the outside; (b3) to set, as a specific mark, a mark corresponding to a specific position of the wheel stopped after the rotation; (b4) when the specific mark and the bet area on which the game value is bet have a corresponding relation, to award a payout, based on the game value that is bet on the bet area corresponding to the specific mark and the payout rate that is set for the bet area corresponding to the specific mark and corresponds to the bet operation received by the input device from the outside; (b5) when the bet operation received by the input device from the outside is the special operation and the payout is awarded, to randomly determine whether to award a bonus payout; and (b6) when it is determined that the bonus payout is awarded, to award the bonus payout.

According to the above structure, when a bet area on which a game value is bet and a specific mark have a corresponding relation, a payout is awarded, based on the game value bet and a payout rate corresponding to a bet operation. When the bet operation is a special operation and the payout is awarded, a bonus payout may be awarded. Like this, when a payout is awarded in a main game, there occurs a possibility that a bonus payout will be awarded. Therefore, a player does not lose an interest in the main game. In addition, since a base rate (so-called, odds) that is a payout rate corresponding to a base operation and a special rate that is a payout rate corresponding to a special operation are set to be different, a payout in the main game is low regardless of whether or not a bonus payout is awarded so that a decrease in the earnings of a game arcade is suppressed. Thereby, a player does not lose an interest in the main game and a bonus is provided which suppresses a decrease in the earnings of a game.

The invention provides a gaming machine including: a wheel device in which a wheel having a plurality of marks disposed thereon is rotated; a display that displays a plurality of bet areas each of which corresponds to at least one mark and on each of which a game value is bet; an input device that receives, as a bet operation, a base operation and a special operation of betting the game value on any one bet area from the outside; and a controller programmed to operate as described in the steps of (c1) to (c6). Specifically, the controller operates: (c1) to respectively set, as payout rates, a base rate corresponding to the base operation and a special rate corresponding to the special operation and having a rate different from the base rate, for each of the bet areas, and to set a bonus payout rate for each bet area; (c2) to bet the game value on the bet area corresponding to the bet operation that is received by the input device from the outside; (c3) to set, as a specific mark, a mark corresponding to a specific position of the wheel stopped after the rotation; (c4) when the specific mark and the bet area on which the game value is bet have a corresponding relation, to award a payout, based on the game value that is bet on the bet area corresponding to the specific mark and the payout rate that is set for the bet area corresponding to the specific mark and corresponds to the bet operation received by the input device from the outside; (c5) when the bet operation received by the input device from the outside is the special operation and the payout is awarded, to randomly determine whether to award a bonus payout; and (c6) when it is determined that the bonus payout is awarded, to award the bonus payout, based on the game value bet on the bet area corresponding to the specific mark and the bonus payout rate set for the bet area corresponding to the specific mark.

According to the above structure, when a bet area on which a game value is bet and a specific mark have a corresponding relation, a payout is awarded, based on the game value bet and a payout rate corresponding to a bet operation. When the bet operation is a special operation and the payout is awarded, a bonus payout may be awarded, based on a game value bet and a bonus payout rate. Like this, when a payout is awarded in a main game, there occurs a possibility that a bonus payout will be awarded. Therefore, a player does not lose an interest in the main game. In addition, since a base rate (so-called, odds) that is a payout rate corresponding to a base operation and a special rate that is a payout rate corresponding to a special operation are set to be different, a payout in the main game is low regardless of whether or not a bonus payout is awarded, so that a decrease in the earnings of a game arcade is suppressed. Thereby, a player does not lose an interest in the main game and a bonus is provided which suppresses a decrease in the earnings of a game. In addition, since the bonus payout is based on the game value bet and the bonus payout rate, when a bet is made on the bet area having bonus payout rate that is set high and a payout is thus awarded, there occurs a possibility that a large amount of a bonus payout will be awarded to the player, so that a player's expectation is increased.

The invention provides a gaming machine including: a wheel device in which a wheel having a plurality of marks disposed thereon is rotated; a display that displays a plurality of bet areas each of which corresponds to at least one mark and on each of which a game value is bet; an input device that receives, as a bet operation, a base operation and a special operation of betting the game value on any one bet area from the outside; and a controller programmed to operate as described in the steps of (d1) to (d6). Specifically, the controller operates: (d1) to respectively set, as payout rates, a base rate corresponding to the base operation and a special rate corresponding to the special operation and having a rate different from the base rate, for each of the bet areas; (d2) to bet the game value on the bet area corresponding to the bet operation that is received by the input device from the outside; (d3) to set, as a specific mark, a mark corresponding to a specific position of the wheel stopped after the rotation; (d4) when the specific mark and the bet area on which the game value is bet do not have a corresponding relation, to increase a count, and when the specific mark and the bet area on which the game value is bet have a corresponding relation, to reset the count and to award a payout, based on the game value that is bet on the bet area corresponding to the specific mark and the payout rate that is set for the bet area corresponding to the specific mark and corresponds to the bet operation received by the input device from the outside; (d5) when the bet operation received by the input device from the outside is the special operation and the payout is awarded, to randomly determine whether to award a bonus payout; and (d6) when it is determined that the bonus payout is awarded, to award the bonus payout, based on a rate corresponding to a count before the reset.

According to the above structure, when a bet area on which a game value is bet and a specific mark do not have a corresponding relation, a count is increased, and when a bet area on which a game value is bet and a specific mark have a corresponding relation, a count is reset and a payout is awarded, based on the game value bet and a payout rate corresponding to a bet operation. When the bet operation is a special operation and the payout is awarded, a bonus payout may be awarded, based on a rate corresponding to a count before the reset. Like this, when a payout is awarded in a main game, there occurs a possibility that a bonus payout will be awarded. Therefore, a player does not lose an interest in the main game. In addition, since a base rate (so-called, odds) that is a payout rate corresponding to a base operation and a special rate that is a payout rate corresponding to a special operation are set to be different, a payout in the main game is low regardless of whether or not a bonus payout is awarded, so that a decrease in the earnings of a game arcade is suppressed. Thereby, a player does not lose an interest in the main game and a bonus is provided which suppresses a decrease in the earnings of a game. In addition, since the bonus payout is based on a rate corresponding to a count before the reset, when a rate is made to be higher as the count is increased, a player who loses a game all the time is provided to a chance that a large amount of a bonus payout will be awarded, so that a player's motivation is maintained.

The invention provides a gaming machine including: a wheel device in which a wheel having a plurality of marks disposed thereon is rotated; a display that displays a plurality of bet areas each of which corresponds to at least one mark and on each of which a game value is bet; an input device that receives, as a bet operation, a base operation and a special operation of betting the game value on any one bet area from the outside; and a controller programmed to operate as described in the steps of (e1) to (e6). Specifically, the controller operates: (e1) to respectively set, as payout rates, a base rate corresponding to the base operation and a special rate corresponding to the special operation and having a rate different from the base rate, for each of the bet areas, and to set a bonus payout rate for each bet area; (e2) to bet the game value on the bet area corresponding to the bet operation that is received by the input device from the outside; (e3) to set, as a specific mark, a mark corresponding to a specific position of the wheel stopped after the rotation; (e4) when the specific mark and the bet area on which the game value is bet do not have a corresponding relation, to increase a count, and when the specific mark and the bet area on which the game value is bet have a corresponding relation, to reset the count and to award a payout, based on the game value that is bet on the bet area corresponding to the specific mark and the payout rate that is set for the bet area corresponding to the specific mark and corresponds to the bet operation received by the input device from the outside; (e5) when the bet operation received by the input device from the outside is the special operation and the payout is awarded, to randomly determine whether to award a bonus payout; and (e6) when it is determined that the bonus payout is awarded, to award the bonus payout, based on the game value bet on the bet area corresponding to the specific mark, a bonus payout rate set for the bet area corresponding to the specific mark and a rate corresponding to a count before the reset.

According to the above structure, when a bet area on which a game value is bet and a specific mark do not have a corresponding relation, a count is increased, and when a bet area on which a game value is bet and a specific mark have a corresponding relation, a count is reset and a payout is awarded, based on the game value bet and a payout rate corresponding to a bet operation. When the bet operation is a special operation and the payout is awarded, a bonus payout may be awarded, based on the game value bet, a bonus payout rate and a rate corresponding to a count before the reset. Like this, when a payout is awarded in a main game, there occurs a possibility that a bonus payout will be awarded. Therefore, a player does not lose an interest in the main game. In addition, since a base rate (so-called, odds) that is a payout rate corresponding to a base operation and a special rate that is a payout rate corresponding to a special operation are set to be different, a payout in the main game is low regardless of whether or not a bonus payout is awarded, so that a decrease in the earnings of a game arcade is suppressed. Thereby, a player does not lose an interest in the main game and a bonus is provided which suppresses a decrease in the earnings of a game. In addition, since the bonus payout is based on the game value bet and a bonus payout rate, when a bet is made on the bet area having bonus payout rate that is set high and a payout is thus awarded, there occurs a possibility that a large amount of a bonus payout will be awarded to the player, so that a player's expectation is increased. Further, since the bonus payout is based on a rate corresponding to a count before the reset, when a rate is made to be higher as the count is increased, a player who loses a game all the time is provided to a chance that a large amount of a bonus payout will be awarded, so that a player's motivation is maintained.

The invention provides a playing method of a gaming machine that repeatedly executes a unit game of rotating a wheel having a plurality of marks disposed thereon, the method including the steps of: (f1) respectively setting, as payout rates, a base rate corresponding to a base operation that is a bet operation of betting a game value on any one bet area and a special rate corresponding to a special operation that is the bet operation and having a rate different from the base rate, for each of bet areas; (f2) betting the game value on the bet area corresponding to the bet operation that is received from the outside; (f3) setting, as a specific mark, a mark corresponding to a specific position of the wheel stopped after the rotation; (f4) when the specific mark and the bet area on which the game value is bet have a corresponding relation, awarding a payout, based on the game value that is bet on the bet area corresponding to the specific mark and the payout rate that is set for the bet area corresponding to the specific mark and corresponds to the bet operation received from the outside; (f5) when the bet operation received from the outside is the special operation and the payout is awarded, randomly determining whether to award the bonus payout; and (f6) when it is determined that the bonus payout is awarded, awarding the bonus payout.

According to the above structure, when a bet area on which a game value is bet and a specific mark have a corresponding relation, a payout is awarded, based on the game value bet and a payout rate corresponding to a bet operation. When the bet operation is a special operation and the payout is awarded, a bonus payout may be awarded. Like this, when a payout is awarded in a main game, there occurs a possibility that a bonus payout will be awarded. Therefore, a player does not lose an interest in the main game. In addition, since a base rate (so-called, odds) that is a payout rate corresponding to a base operation and a special rate that is a payout rate corresponding to a special operation are set to be different, a payout in the main game is low regardless of whether or not a bonus payout is awarded, so that a decrease in the earnings of a game arcade is suppressed. Thereby, a player does not lose an interest in the main game and a bonus is provided which suppresses a decrease in the earnings of a game.

Furthermore, according to the above structures, it is possible to provide a gaming machine having an entertainment characteristic, which is not provided to the prior art, and a playing method thereof.

### BRIEF DESCRIPTION OF THE DRAWINGS

FIG. 1 illustrates a playing method of a gaming machine.

FIG. 2 is a block diagram of a gaming machine.

FIG. 3 illustrates a display screen.

FIG. 4 illustrates a display screen.

FIG. 5 is a perspective view showing an external appearance of a gaming machine.

FIG. 6 is a plan view of a wheel.

FIG. 7 is a block diagram schematically showing an electrical structure of a gaming machine.

FIG. 8 is a block diagram schematically showing an electrical structure of a station.

FIG. 9 shows an ODDS management table.

FIG. 10 shows a bonus rate management table.

FIG. 11 is a flow chart of a game process.

### DESCRIPTION OF THE PREFERRED EMBODIMENTS

Hereinafter, a gaming machine and a playing method thereof according to an embodiment of the invention will be described. In the mean time, a gaming machine of the invention is a gaming machine that a player who expects a mark such as number to be determined in a wheel device bets a game value such as chip possessed on the expected mark and a game medium such as medal and a game value such as credit are provided to the player when a winning is made for the mark bet.

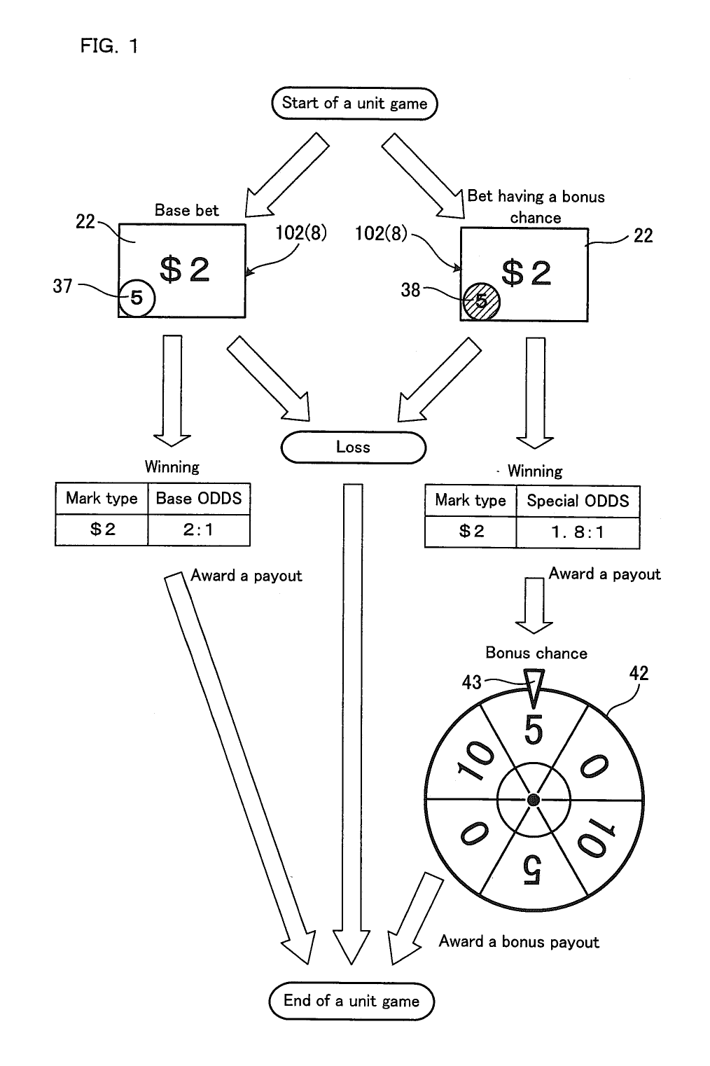

As shown in FIG. 1, a gaming machine 1 repeatedly executes a unit game of rotating a wheel having a plurality of marks disposed thereon and executes a playing method including the steps of: respectively setting, as payout rates, a base rate corresponding to a base operation and a special rate having a rate different from the base rate, for each of bet areas; betting a game value on the bet area corresponding to a bet operation that is received from the outside; setting, as a specific mark, a mark corresponding to a specific position of the wheel stopped after the rotation; when the specific mark and the bet area on which the game value is bet have a corresponding relation, awarding a payout, based on the game value that is bet on the bet area corresponding to the specific mark and a payout rate that is set for the bet area corresponding to the specific mark and corresponds to the bet operation received from the outside; when the bet operation received from the outside is a special operation and the payout is awarded, randomly determining whether to award a bonus payout; and when it is determined that the bonus payout is awarded, awarding the bonus payout.

Here, the “special operation” means a bet operation of betting a game value in a main game and betting a game value on a “bonus chance” at the same time. When a winning is made in a main game in the “special operation,” a payout that is smaller than a case where a same amount of the game value is bet by a “base operation” is provided to a player, and when a “bonus chance” is executed and a winning is made the bonus chance, a bonus payout is awarded to the player.

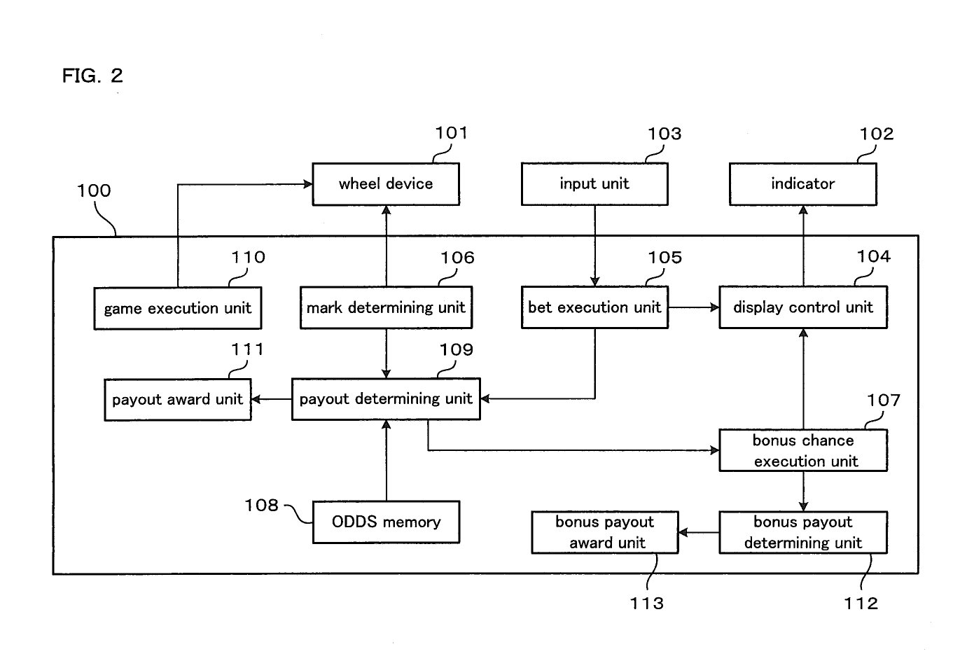

The gaming machine 1 that executes the above playing method includes a wheel device 101 serving as a specific mark determining device, an indicator (display) 102, an input unit (input device) 103 and a controller 100, as shown in FIG. 2.

(Wheel Device 101)

The wheel device 101 is a device that selects one of marks and determines it as a specific mark. The wheel device 101 has a physical structure with a wheel having marks disposed thereon and a stopper indicating a specific position of the wheel. In the mean time, the wheel device 101 may have an electrical structure that displays a wheel screen on which a wheel is rotation-displayed. The electrical structure may include a liquid crystal display device, a CRT (Cathode-ray tube) device, a plasma display and the like. The detailed structure of the wheel device 101 will be described later.

(Indicator 102)

The indicator (display) 102 is electrically structured to display the bet areas. In the mean time, the indicator 102 may have a physical structure with a table having bet areas depicted thereon and the like. The electrical structure may include a liquid crystal device, a CRT (Cathode-ray tube) device, a plasma display and the like. The detailed structure of the indicator 102 will be described later.

(Input Unit 103)

The input unit (input device) 103 is operated so as to bet a chip (game value) on one of the bet areas displayed on the indicator 102. Here, the input unit 103 receives, as a bet operation, a base operation that does not accompany a “bonus chance” and a special operation that accompanies a “bonus chance.” In the mean time, as described below, the input unit 103 may include a touch panel provided to a front of the indicator 102, or alternatively include several buttons.

(Controller 100)

The controller 100 is configured to execute a first process of respectively setting, as payout rates, a base rate corresponding to a base operation and a special rate corresponding to a special operation and having a rate different from the base rate, for each of bet areas displayed on the display (indicator 102); a second process of betting a game value (chip) on the bet area corresponding to a bet operation that is received by an input device (input unit 103) from the outside; a third process of setting, as a specific mark, a mark corresponding to a specific position of the wheel stopped after the rotation; and a fourth process of when the specific mark and the bet area on which the game value is bet have a corresponding relation, awarding a payout (credit), based on the game value that is bet on the bet area corresponding to the specific mark and a payout rate that is set for the bet area corresponding to the specific mark and corresponds to the bet operation received by the input device from the outside. In other words, the controller 100 has a first processing unit, a second processing unit, a third processing unit and a fourth processing unit.

In addition, the controller 100 is configured to execute a fifth process of when the bet operation received by the input device (input unit 103) from the outside is a special operation and the payout is awarded, randomly determining whether to award a bonus payout; and a sixth process of when it is determined that the bonus payout is awarded, awarding the bonus payout. In other words, the controller 100 has a fifth processing unit and a sixth processing unit.

The controller 100 includes a bet execution unit 105 that executes a bet of a chip, based on an operation signal from the input unit 103, and a display control unit 104 that controls the indicator 102 to display the bet areas. The bet execution unit 105 executes a base bet when a bet operation received by the input unit 103 is a base operation that does not accompany a “bonus chance” and executes a special bet when a bet operation received by the input unit 103 is a special operation that accompanies a “bonus chance.” When the bet execution unit 105 executes a bet (base bet, special bet), the display control unit 104 displays bet information on a corresponding bet area. A detailed display state will be described later. Meantime, each of the bet areas is made to correspond to one mark, respectively. In other words, the controller 100 executes a second process of betting a game value (chip) on a bet area corresponding to a bet operation received by the input device (input unit 103) from the outside, among the bet areas displayed on the display (indicator 102).

In addition, the controller 100 has a game execution unit 110 that enables the wheel device 101 to randomly select one of the marks and to determine it as a specific mark. To be more specific, the game execution unit 110 enables the wheel device 101 to rotate a wheel having the marks disposed thereon, thereby randomly selecting one of the marks and determining it as a specific mark. In addition, the controller 100 has a mark determining unit 106 that determines which marks is a mark corresponding to a specific position of the wheel stopped after the rotation in the wheel device 101. The controller 100 sets the mark determined by the mark determining unit 106, as a specific mark. In other words, the controller 100 executes a third process of setting, as a specific mark, a mark corresponding to a specific position of the wheel stopped after the rotation.

In addition, the controller 100 has an ODDS memory 108 that stores, as payout rates (so-called ODDS), a base rate (base ODDS) corresponding to a base operation that is a bet operation that does not accompany a “bonus chance” and a special rate (special ODDS) corresponding to a special operation that is a bet operation that accompanies a “bonus chance,” respectively. Here, in this embodiment, the special rate is set to be lower than the base rate. In other words, the controller 100 executes a first process of respectively setting, as payout rates, a base rate corresponding to a base operation and a special rate corresponding to a special operation and having a rate different from the base rate, for each of bet areas.

In addition, the controller 100 has a payout determining unit 109 that determines a payout to be awarded to a player and a payout award unit 111 that awards a payout to a player. The payout determining unit 109 refers to the bet (base bet, special bet) executed by the bet execution unit 105 and the specific mark determined by the mark determining unit 106 to determine whether the specific mark and the bet area on which the chip is bet have a corresponding relation. When the specific mark and the bet area on which the chip is bet have a corresponding relation, the payout determining unit 109 makes a winning and calculates a payout (credit) based on the chip set for the bet area corresponding to the specific mark and the payout rate that is set for the bet area corresponding to the specific mark and corresponds to the bet operation received by the input device (input unit 103) from the outside. The calculated payout is awarded to a player by the payout award unit 111. In other words, the controller 100 executes a fourth process of when the specific mark and the bet area on which the game value is bet have a corresponding relation, awarding a payout (credit), based on the game value that is bet on the bet area corresponding to the specific mark and a payout rate that is set for the bet area corresponding to the specific mark and corresponds to the bet operation received by the input device from the outside.

Furthermore, the controller 100 has a bonus chance execution unit 107. When the bet executed by the bet execution unit 105 is a special bet and a payout is awarded to a player by the payout award unit 111, the bonus chance execution unit 107 executes a “bonus chance” and randomly determines whether to award a bonus payout. In the mean time, it may be possible that a bonus determining device that randomly determines whether to award a bonus payout is separately provided and the bonus chance execution unit 107 operates the bonus determining device to determine whether to award a bonus payout. In other words, the controller 100 executes a fifth process of when the bet operation received by the input device (input unit 103) from the outside is a special operation and the payout is awarded, randomly determining whether to award a bonus payout.

Further, the controller 100 has a bonus payout determining unit 112 that determines whether to award a bonus payout and a bonus payout award unit 113 that awards a bonus payout to a player. When the bonus chance execution unit 107 determines that the bonus chance execution unit 107 awards a bonus payout, the bonus payout determining unit 112 calculates a bonus payout (credit). The calculated bonus payout is awarded to a player by the bonus payout award unit 113. In other words, the controller 100 executes a sixth process of when it is determined that the bonus payout is awarded, awarding the bonus payout.

In the mean time, each block of the controller 100 may be embodied in hardware or software, as required.

(Operation of the Controller 100)

In the followings, an operation of the controller 100 will be described. Firstly, a base rate (base ODDS) corresponding to a base operation that is a bet operation that does not accompany a “bonus chance” and a special rate (special ODDS) corresponding to a special operation that is a bet operation that accompanies a “bonus chance” are respectively stored as payout rates, for each of the bet areas, in the ODDS memory 108. Thereby, the controller 100 executes a first process of respectively setting, as payout rates, a base rate corresponding to a base operation and a special rate corresponding to a special operation and having a rate different from the base rate, for each of bet areas.

The bet information inputted from the input unit 103 is inputted to the bet execution unit 105 and the inputted bet information is displayed on the indicator 102 by the display control unit 104. Thereby, the controller 100 executes a second process of betting a game value (chip) on the bet area corresponding to a bet operation that is received by an input device (input unit 103) from the outside, among the bet areas displayed on the display (indicator 102). As the wheel device 101 is operated by the game execution unit 110, one of the marks is randomly selected and determined as a specific mark. The specific mark is determined by the mark determining unit 106. Thereby, the controller 100 executes a third process of setting, as a specific mark, a mark corresponding to a specific position of the wheel stopped after the rotation.

The payout determining unit 109 determines whether the specific mark and the bet area on which a chip is bet have a corresponding relation. When the specific mark and the bet area on which a chip is bet have a corresponding relation, a winning is made, so that a payout (credit) is calculated, based on the chip bet on the bet area corresponding to the specific mark and the payout rate that is set for the bet area corresponding to the specific mark and corresponds to a bet operation received by the input device (input unit 103) from the outside. The calculated payout is awarded to a player by the payout award unit 111. Thereby, the controller 100 executes a fourth process of when the specific mark and the bet area on which the game value is bet have a corresponding relation, awarding a payout (credit), based on the game value that is bet on the bet area corresponding to the specific mark and a payout rate that is set for the bet area corresponding to the specific mark and corresponds to the bet operation received by the input device from the outside.

When the bet executed by the bet execution unit 105 is a special bet and the payout is awarded to a player by the payout award unit 111, the bonus chance execution unit 107 executes a “bonus chance” to randomly determine whether to award a bonus payout. Thereby, the controller 100 executes a fifth process of when the bet operation received by the input device (input unit 103) from the outside is a special operation and the payout is awarded, randomly determining whether to award a bonus payout.

When the bonus chance execution unit 107 determines that a bonus payout is awarded, a bonus payout (credit) is calculated by the bonus payout determining unit 112. The calculated bonus payout is awarded to a player by the bonus payout award unit 113. Thereby, the controller 100 executes a sixth process of when it is determined that the bonus payout is awarded, awarding the bonus payout.

As clearly seen from the above operations, the gaming machine 1, as shown in FIG. 1, repeatedly executes a unit game of rotating a wheel having a plurality of marks disposed thereon and realizes a playing method including the steps of: respectively setting, as payout rates, a base rate corresponding to a base operation (operation of performing a base bet) that is a bet operation of betting a game value on one of bet areas and a special rate corresponding to a special operation (operation of performing a bet having a bonus chance) that is a bet operation and having a rate different from the base rate, for each of the bet areas; betting a game value on the bet area corresponding to a bet operation that is received from the outside; setting, as a specific mark, a mark corresponding to a specific position of the wheel stopped after the rotation; when the specific mark and the bet area on which the game value is bet have a corresponding relation, awarding a payout, based on the game value that is bet on the bet area corresponding to the specific mark and a payout rate that is set for the bet area corresponding to the specific mark and corresponds to the bet operation received from the outside; when the bet operation received from the outside is a special operation and the payout is awarded, randomly determining whether to award a bonus payout; and when it is determined that the bonus payout is awarded, awarding the bonus payout.

According to the playing method, when a bet area on which a game value is bet and a specific mark have a corresponding relation, a payout is awarded, based on the game value bet and a payout rate corresponding to a bet operation. When the bet operation is a special operation and the payout is awarded, a bonus payout may be awarded. Like this, when a payout is awarded in a main game, there occurs a possibility that a bonus payout will be awarded. Therefore, a player does not lose an interest in the main game. In addition, since a base rate that is a payout rate (so-called, odds) corresponding to a base operation and a special rate that is a payout rate corresponding to a special operation are set to be different, a payout in the main game is low regardless of whether or not a bonus payout is awarded so that a decrease in the earnings of a game arcade is suppressed. Thereby, a player does not lose an interest in the main game and a bonus is provided which suppresses a decrease in the earnings of a game.

(Display State)

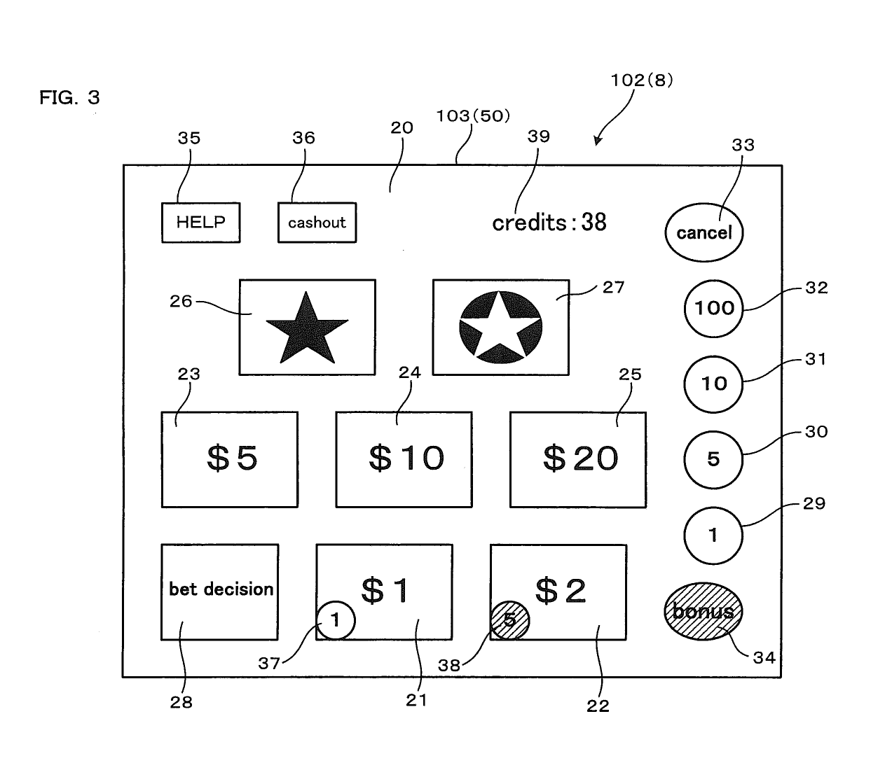

An example of a display state of the indicator (display) 102 in the operating processes of the gaming machine 1 and the playing method thereof will be specifically described. In the mean time, the display state will be described on the basis of an electrical structure that the indicator 102 displays a BET screen 20 including bet areas 21 to 27, and the like, as shown in FIG. 3.

When a unit game is started in the gaming machine 1, a BET screen 20 including the bet areas 21 to 27 is displayed in the indicator 102, as shown in FIG. 3. In the mean time, a front of the indicator 102 is provided with a light transmissive touch panel 50 that is press-operable from the outside, as an input unit (input device) 103. Due to this, the description that various parts on the BET screen 20, such as bet areas 21 to 27, are pressed means that the various parts corresponding to the bet areas 21 to 27 of the touch panel 50 are pressed by a player.

As shown in FIG. 3, a bet area 21 of “$1,” a bet area 22 of “$2,” a bet area 23 of “$5,” a bet area 24 of “$10,” a bet area 25 of “$20,” a bet area 26 of a “first star mark” and a bet area 27 of a “second star mark” are displayed on the BET screen 20. In addition, bet buttons 29 to 32 for betting a chip are displayed on the BET screen 20.

Furthermore, on the BET screen 20 are displayed a bonus button 34 that is pushed when making a bet (special bet) having a bonus chance, a cancel button 33 that is pushed when a bet is canceled, a bet decision button 28 for deciding a bet, a help button 35 that a player pushes when an operating method of a game is unclear, thereby displaying a help screen, and a cashout button 36 for paying out a credit as a chip. In addition, a credit-number indicator 39 that displays a credit-number currently possessed by a player is displayed on the BET screen 20.

The bet buttons 29 to 32 are buttons for betting a chip on a bet area indicated by a player. The bet buttons 29 to 32 include four types of a 1 bet button 29 that bets a credit-number of “1,” a 5 bet button 30 that bets a credit-number of “5,” a 10 bet button 31 that bets a credit-number of “10” and a 100 bet button 32 that bets a credit-number of “100.”

On the credit-number indicator 39 is displayed a credit-number that is currently possessed by a player. When a chip is bet, the credit-number is decreased in accordance with the bet-number (one credit per one chip). In addition, when a winning is made in a unit game and the cashout of the credits is thus made, the credit is increased as the cashout-number. Meanwhile, when the credit-number possessed by a player becomes 0, a game is over.

As shown in FIG. 3, when a bet is made by a base bet, a mark 37 showing a bet-amount is displayed on the bet area on which the bet is made. In addition, when a bet is made by a bet having a bonus chance, a mark 38 showing a bet-amount is displayed on the bet area on which the bet is made, in a pattern different from the mark 37.

In the mean time, a payout rate (base rate, base ODDS) in a base bet, a payout rate (special rate, special ODDS) in a bet having a bonus chance and a bonus payout rate (bonus ODDS) that is referred to when a winning is made in a “bonus chance” are set for each of the bet areas 21 to 27. Here, the payout rate (ODDS) (including the payout rate) is a payout-number of credits for a winning per one chip. The payout rate will be specifically described later.

When a bet is made on the BET screen 20 structured as described above, one of the bet buttons 29 to 32 is pushed to determine a bet-amount. At this time, when the bet buttons 29 to 32 only are pushed, a base bet is made. When the bonus button 34 is pushed in addition to the bet buttons 29 to 32, a bet having a bonus chance is made. Then, when one of the bet areas 21 to 27 is pushed, a bet area that becomes a bet object is determined. After the above operation is repeated, the bet decision button 28 is pushed to decide a bet in a unit game.

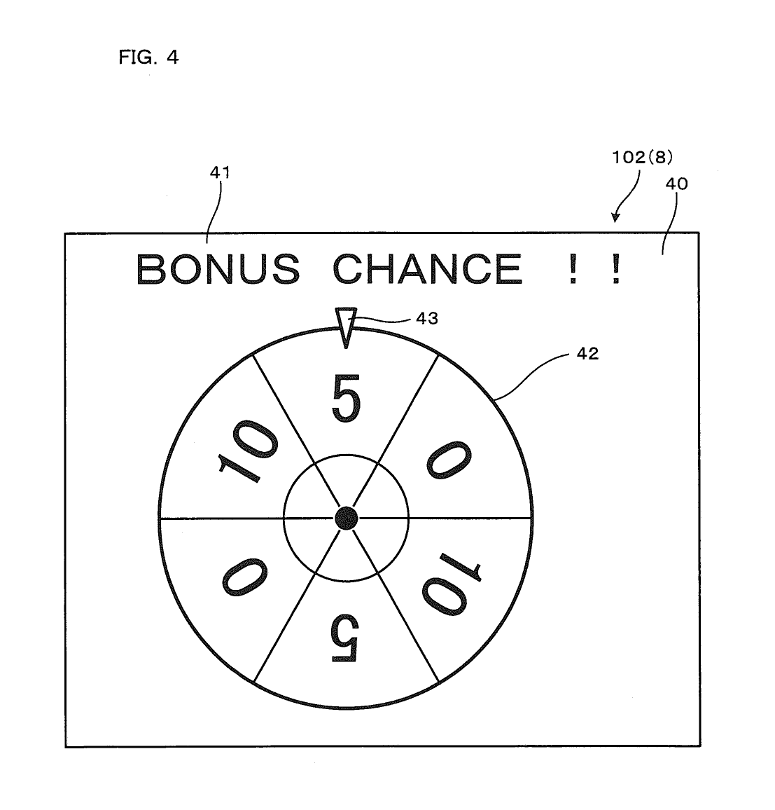

In addition, when a bet is made in a bet having a bonus chance and a winning is thus made, a “bonus chance” is executed and a bonus chance screen 40 is displayed on the indicator 102, as shown in FIG. 4.

On the bonus chance screen 40 are displayed a letter image 41 showing a “bonus chance,” a wheel 42 that is divided into 6 areas on which numbers are depicted, and a needle 43. Then, the wheel 42 is rotated and stopped after a predetermined time has elapsed. When the wheel 42 is stopped, the number indicated by the needle 43 is determined as a bonus rate. Then, based on the determined bonus rate and the bonus ODDS, a bonus payout is determined and is awarded to a player. In the mean time, the bonus rate is structured to change depending on a “defeat game-number” that will be described later.

(Mechanical Structure of the Gaming Machine 1)

In the followings, a mechanical structure of the gaming machine 1 will be described.

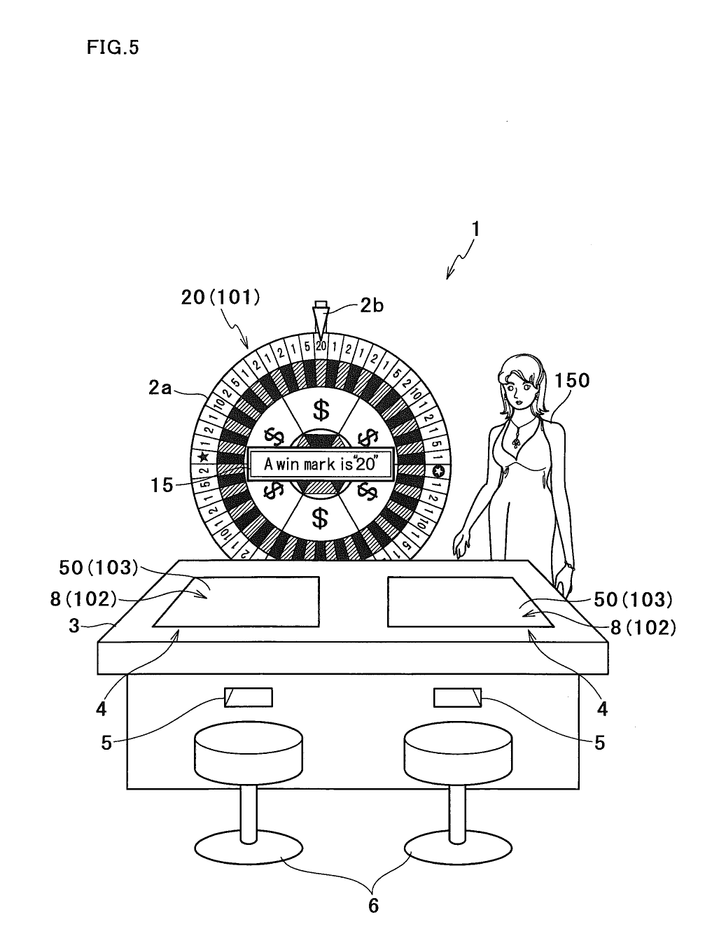

As shown in FIG. 5, the gaming machine 1 has a cabinet 3 that is a main body, a wheel device 2 (wheel device 101) that is provided to a back of the cabinet 3 and is operated by a dealer 150 and stations 4 (2 stations in this embodiment) that are provided to the cabinet 3 to be opposite to the wheel device 2.

Here, the station 4 is a bet unit with which a player's bet operation that is performed while expecting a win mark (specific mark) to be determined by the wheel device 2 is inputted. The station has at least, a medal insertion slot (not shown) into which a game medium such as bill or medal is inserted, a touch panel 50 (input device 103) with which a player inputs a predetermined instruction and a liquid crystal display device 8 (indicator (display) 102) that displays an image relating to a game, and a game area that receives a player's bet operation. In the mean time, the two or more stations 4 or only one station 4 may be provided to the cabinet 3.

The liquid crystal display device 8 is a touch panel-type liquid crystal display having the touch panel 50 attached to a front thereof. When a player recognizing an image displayed on the liquid crystal display device 8 operates the touch panel 50, a game is progressed.

In addition, sides of the cabinet 3 to which the stations 4 are equipped are provided with medal payout slots 5, respectively. In addition, the cabinet 3 is provided with a speaker 10 (not shown) that generates music, an effect sound and the like. The front of the cabinet 3 is provided with chairs 6 on which a player sits.

Furthermore, the cabinet 3 has a server 80 therein. The server 80 is associated with each of the station 4, and transmits a command signal to each of the stations 4 to initiatively control each of the stations 4, thereby progressing a game. In addition, the cabinet 3 is provided with an input device 16 (not shown) that is associated with the server 80 and is operated by the dealer 150. To the input device 16 is inputted a win mark and the like by the dealer 150 who manually operates the wheel device 2.

In addition, a medal sensor (not shown) is provided in the medal insertion slot. The medal sensor validates a medal inserted into the medal insertion slot and counts the inserted medal. In addition, a hopper 94 (not shown) is provided in the medal payout slot 5, which pays out the predetermined number of medals from the medal payout slot 5.

The server 80 is associated with a liquid crystal display and a keyboard, which are not shown. The liquid crystal display displays a menu screen or maintenance screen. In addition, the keyboard is an operating device having several keys disposed thereon. In a state that a menu screen or maintenance screen is displayed on the liquid crystal display, when an operator operates it, the maintenance operation as well as various settings in the gaming machine 1 is made.

The wheel device 2 is divided into several areas and includes a wheel 2a having rods (not shown) stuck on boundaries between the respective areas, a stopper 2b that contacts the rods to roll from side to side, and an electric light indicator 15 that is provided to a center of the wheel 2a. The wheel 2a is rotated by the dealer 150 and the rods provided to the wheel 2a contact the stopper 2b, so that the rotation speed thereof is gradually decreased and is finally stopped. A mark that is indicated by a leading end of the stopper 2b when the wheel 2a is stopped is a win mark.

The electric light indicator 15 displays a letter or image of “please make a bet” while a player makes a bet. The electric light indicator displays an effect image and the like while the wheel 2a is being rotated. The electric light indicator displays a win mark and the like when a win mark is determined.

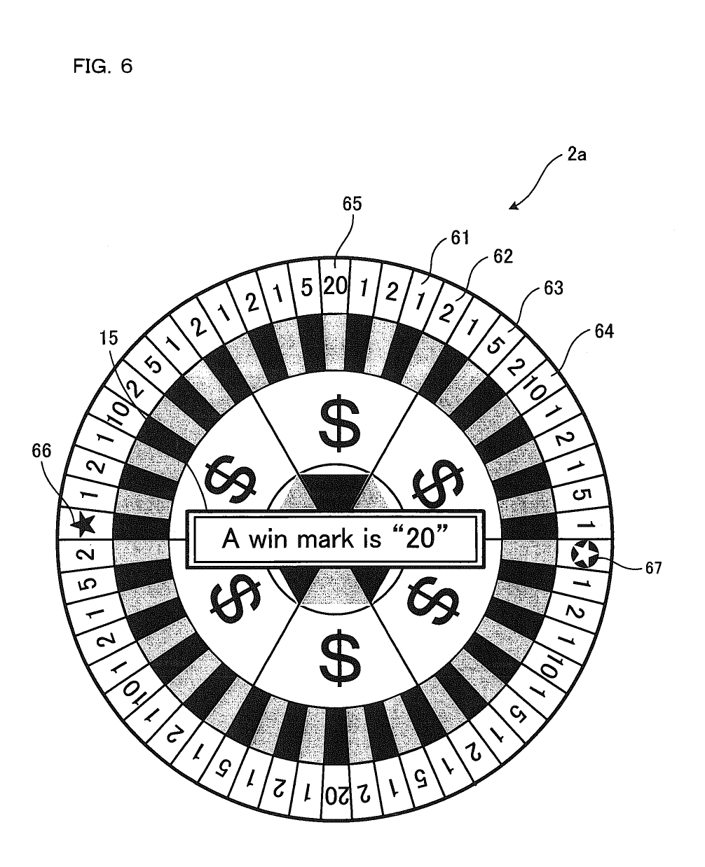

As shown in FIG. 6, the wheel 2a is divided into 54 areas of first 23 areas 61 having a mark of “1” written thereon, second 15 areas 62 having a mark of “2” written thereon, third 8 areas 63 having a mark of “5” written thereon, fourth 8 areas 64 having a mark of “10” written thereon, fifth 2 areas 65 having a mark of “20” written thereon, a sixth one area 66 having a mark of “a first star” and a seventh one area 67 having a mark of “a second star” written thereon. The rods (not shown) are stuck on each of the boundaries between the areas, vertically to a plate surface of the wheel 2a. In addition, the electric light indicator 15 is provided to a center of the wheel 2a. Meantime, the invention is not limited to the structure that the wheel 2a is divided into 54 areas.

(Electrical Structure of the Gaming Machine 1)

In the followings, an electrical structure of the gaming machine 1 will be described.

(Electrical Structure of the Server 80)

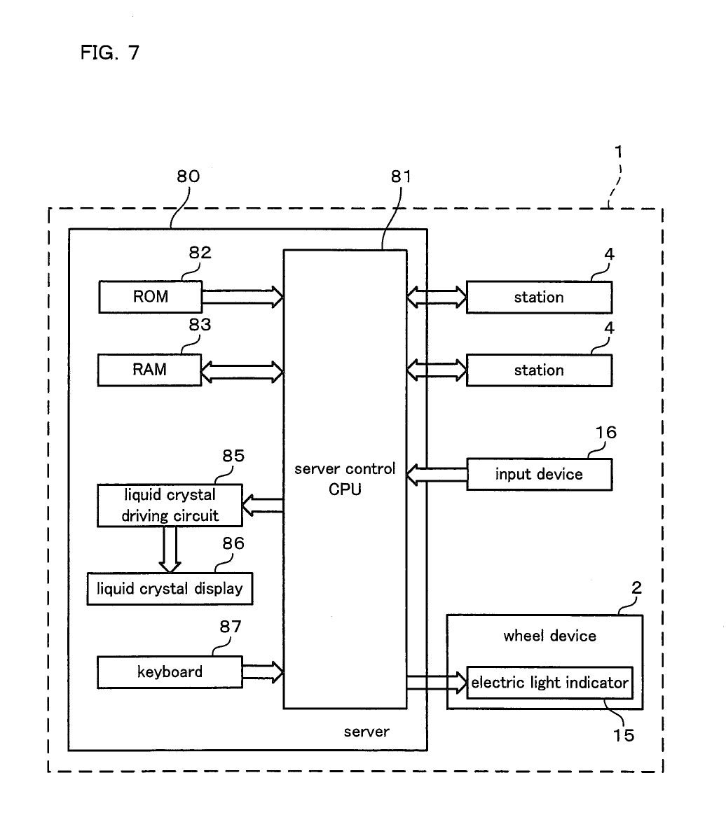

As shown in FIG. 7, the gaming machine 1 includes a server 80 and several stations 4 (2 stations in this embodiment) associated with the server 80. The server 80 is associated with the electric light indicator 15 of the wheel device 2 and an input device 16 that the dealer 150 operates. In the mean time, a control system of the station 4 will be specifically described later.

The server 80 includes a server control CPU 81 serving as a calculation device and a control device performing an entire control, a ROM 82 and a RAM 83, a liquid crystal display 86 associated with the CPU through a liquid crystal driving circuit 85 and a keyboard 87.

The server control CPU 81 executes a variety of processes, based on input signals supplied from the respective stations 4 and data or program stored in the ROM 82 and the RAM 83. Thereby, the server control CPU 81 transmits a command signal to the stations 4 based on execution results of the processes, thereby initiatively controlling the respective stations 4 and progressing a game. Further, the server control CPU 81 performs a winning determination of a chip bet based on one win mark obtained from the input device 16 and the bet information transmitted from each station 4, and calculates a credit-number to be paid out in each station 4. In addition, the server control CPU 81 controls a display by the electric light indicator 15.

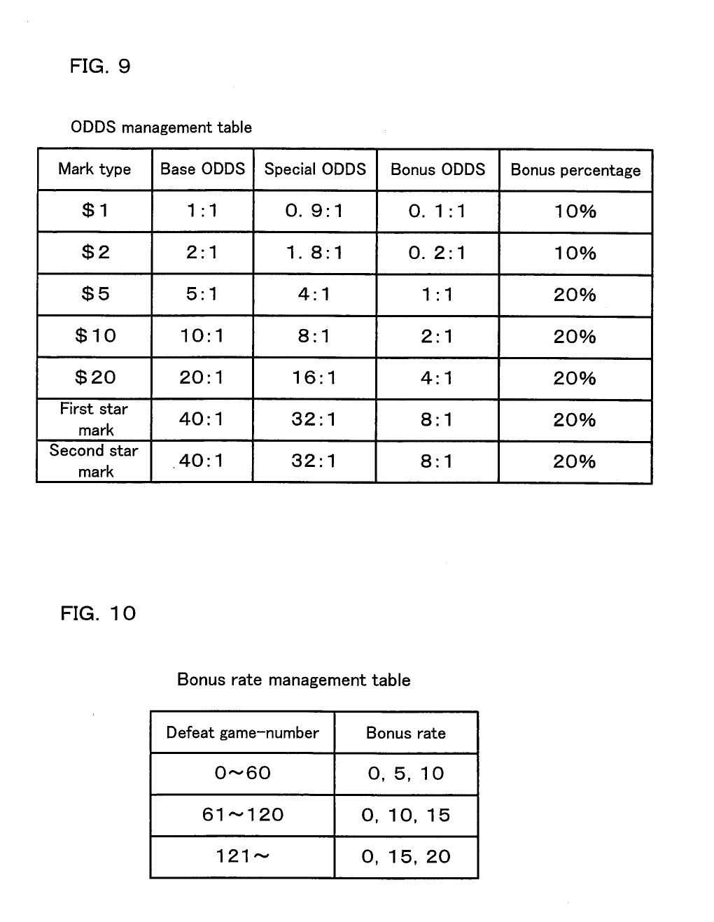

The ROM 82 includes a semiconductor memory, for example. The ROM 82 stores a program for implementing basic functions of the gaming machine 1, a program for initiatively controlling the respective stations 4, and the like. In addition, the ROM 82 stores a payout rate (base ODDS, special ODDS) and a bonus payout rate (bonus ODDS) set for each bet type, as an ODDS management table of FIG. 9. Further, it stores a bonus rate to be used in a “bonus chance,” as a bonus rate management table of FIG. 10.

In the mean time, the RAM 83 temporarily stores the bet information of chips and a defeat game-number to be supplied from the respective stations 4, a win mark of the wheel device 2 inputted to the input device 16, data relating to a result of a process that is executed by the server control CPU 81, and the like.

(Electrical Structure of the Station 4)

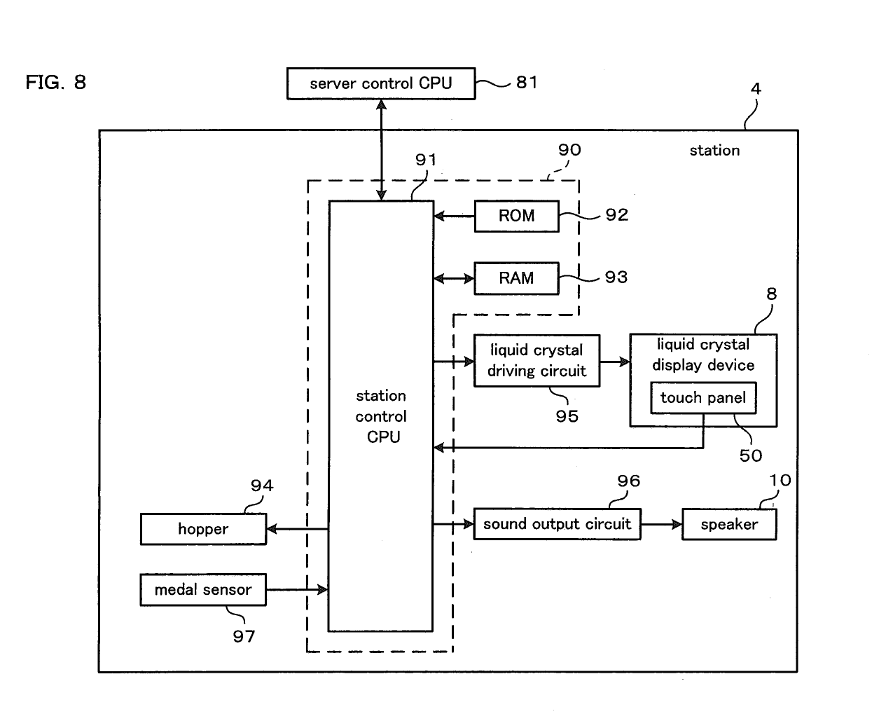

In the followings, a structure of a control system of the stations 4 associated with the server 80 according to this embodiment will be described with reference to FIG. 8. FIG. 8 is a block diagram schematically showing a control system of the station 4 according to an embodiment. In the mean time, the two stations 4 have a same structure, so that one station 4 will be described as an example.

As shown in FIG. 8, the station 4 includes a station control unit 90 and several peripheral devices. The station control unit 90 includes a station control CPU 91, a ROM 92 and a RAM 93. The ROM 92 includes a semiconductor memory, for example. The ROM 92 stores a program for implementing basic functions of the station 4, a program necessary for executing a “bonus chance,” various programs necessary for controlling the station 4, a data table and the like. In addition, the RAM 93 is a memory that temporarily stores various data calculated in the station control CPU 91, the number of credits that are currently possessed by a player (i.e., stored in the station 4), a bet situation of chips by a player, a defeat game-number and the like.

The station control CPU 91 receives a command signal from the server control CPU 81, controls the peripheral devices constituting the station 4 based on the command signal and progresses a unit game in the station 4. In addition, the station control CPU 91 executes a variety of processes, based on an input signal that is supplied from the touch panel 50 as an operation by a player is inputted and the data or program stored in the ROM 92 and the RAM 93, depending on contents of process, controls the peripheral devices constituting the station 4 based on the process results and progresses a unit game in the station 4.

In addition, the station control CPU 91 is associated with a hopper 94. The hopper 94 pays out the predetermined number of medals from the medal payout slot 5 (refer to FIG. 5) in accordance with a command signal from the station control CPU 91.

Furthermore, the station control CPU 91 is associated with a liquid crystal display device 8 through a liquid crystal driving circuit 95. The liquid crystal driving circuit 95 includes a program ROM, an image ROM, an image control CPU, a work RAM, a VDP (video display processor), a video RAM and the like. The program ROM stores an image control program for display on the liquid crystal display device 8, a variety of selection tables and the like. In addition, the image ROM stores dot data for forming an image to be displayed on the liquid crystal display device 8, for example. The image control CPU determines an image to be displayed on the liquid crystal display device 8 from the dot data previously stored in the image ROM, in accordance with an image control program previously stored in the program ROM, based on parameters set in the station control CPU 91. In addition, the work RAM includes a temporary memory device to be used when the image control program is executed in the image control CPU. In addition, the VDP forms an image relating to contents of display determined in the image control CPU and outputs the image on the liquid crystal display device 8. In the mean time, the video RAM includes a temporary memory device to be used when an image is formed in the VDP.

In addition, a touch panel 50 is attached on a front of the liquid crystal display device 8, as described above. Operation information of the touch panel 50 is transmitted to the station control CPU 91. As a player press-operates the touch panel 50, a bet operation of a chip by the player is performed on the BET screen 20. To be more specific, a player performs a selection of the bet areas 21 to 27, an operation of the bet buttons 29 to 32 and the like, and the operation information is transmitted to the station control CPU 91. Based on the information, the current bet information of a player (a bet area indicated, the number of chips bet and a bet type) is stored in the RAM 93 at all times. Furthermore, the bet information is transmitted to the server control CPU 81 and is stored in the bet information memory area of the RAM 83.

Furthermore, the station control CPU 91 is associated with a speaker 10 through a sound output circuit 96. The speaker 10 generates a variety of effect sounds when performing various effects, based on an output signal from the sound output circuit 96.

In addition, a medal sensor 97 is associated with the station control CPU 91. The medal sensor 97 detects medals inserted from the medal insertion slot, calculates the inserted medals and transmits a result thereof to the station control CPU 91. The station control CPU 91 increases the credit-number possessed by a player, which is stored in the RAM 93, based on the transmitted signal.

(ODDS Management Table)

In the followings, an ODDS management table that is referred to when a payout is calculated as a winning is made will be described with reference to FIG. 9. The ODDS management table is stored in the RON 82 of the server 80, and a base ODDS, a special ODDS and a bonus ODDS are set for each of the mark types (bet areas). Here, a base ODDS is a payout rate (ODDS) that corresponds to a base bet that does not accompanying a “bonus chance” in a unit game and a special ODDS is a payout rate (ODDS) that corresponds to a bet (special bet) having a bonus chance that accompanies a “bonus chance” in a unit game. In addition, a bonus ODDS is a payout rate that is referred to when a winning is made in a “bonus chance.”

For example, a base ODDS corresponding to the mark of “$5” is “5:1.” In the mean time, “5:1” means that when a credit (chip) of “1” is bet and a winning is made, the credits of “5” are paid out in addition to the credit of “1.” In other words, when a base bet is made and a winning is made, the credits 6 times as much as an amount bet are paid out.

In addition, a special ODDS corresponding to the mark of “$5” is “4:1.” In other words, when a bet having a bonus chance is made and a winning is made, the credits 5 times as much as an amount bet are paid out. Like this, the special ODDS has a rate lower than the base ODDS.

In addition, a bonus ODDS corresponding to the mark of “$5” is “1:1.” In other words, in this embodiment, a bonus ODDS is set as a difference value between the base ODDS and the special ODDS. A bonus percentage of the mark of “$5” is 20%. In addition, a bonus percentage of the mark of “$1” is 10%. Thereby, for a mark having a higher bonus percentage, when a winning is made in a “bonus chance,” a bonus payout that a player will obtain is larger. In the mean time, the bonus ODDS is not limited to the structure that it is set as a difference value between the base ODDS and the special ODDS.

Like this, since the bonus payout is based on the chips (game value) bet and the bonus ODDS (bonus payout rate), when a bet is made on an area for which a bonus ODDS is set high and a payout is awarded, there occurs a possibility that a larger amount of a bonus payout will be awarded to a player. As a result, a player's expectation is increased.

(Bonus Rate Management Table)

In the followings, a bonus rate management table that is referred to when a bonus payout is calculated in a “bonus chance” will be described with reference to FIG. 10. The bonus rate management table is stored in the ROM 82 of the server 80 and a bonus rate is set to correspond to a defeat game-number (count). Here, the “defeat game-number” means a continuous number of unit games in which a winning is not made. In other words, the more the “defeat game-number,” a player loses a game all the time. In the mean time, the “defeat game-number” is reset at a time at which a winning is made.

When a winning is made in a range of the “defeat game-number” of “0 to 60,” a “bonus chance” using the bonus rates of “0,” “5” and “10” is executed and the bonus rates are displayed on the wheel 42 (refer to FIG. 4). When a winning is made in a range of the “defeat game-number” of “61 to 120,” a “bonus chance” using the bonus rates of “0,” “10” and “15” is executed. When a winning is made in a range of the “defeat game-number” of “121 or more,” a “bonus chance” using the bonus rates of “0,” “15” and “20” is executed. The bonus rates are displayed on the wheel 42. Thereby, the more the “defeat game-number,” a bonus payout that a player will obtain is larger, when a winning is made in a “bonus chance.” In the mean time, a relation of the defeat game-number and the bonus rate is not limited to FIG. 10.

Like this, since the bonus payout is based on the bonus rate corresponding to the “defeat game-number” and the bonus rate is set to be higher as the defeat game-number is increased, a chance that a large amount of the bonus payout will be awarded is provided to a player who loses a game all the time, so that a player's motivation is maintained.

(Processing Operations of the Gaming Machine 1)

In the followings, the operations that are carried out in the gaming machine 1 will be described. The station control CPU 91 of each station 4 and the server control CPU 81 of the server 80 cooperate with each other to execute a game process, thereby progressing a unit game.

(Game Process Performed in the Station)

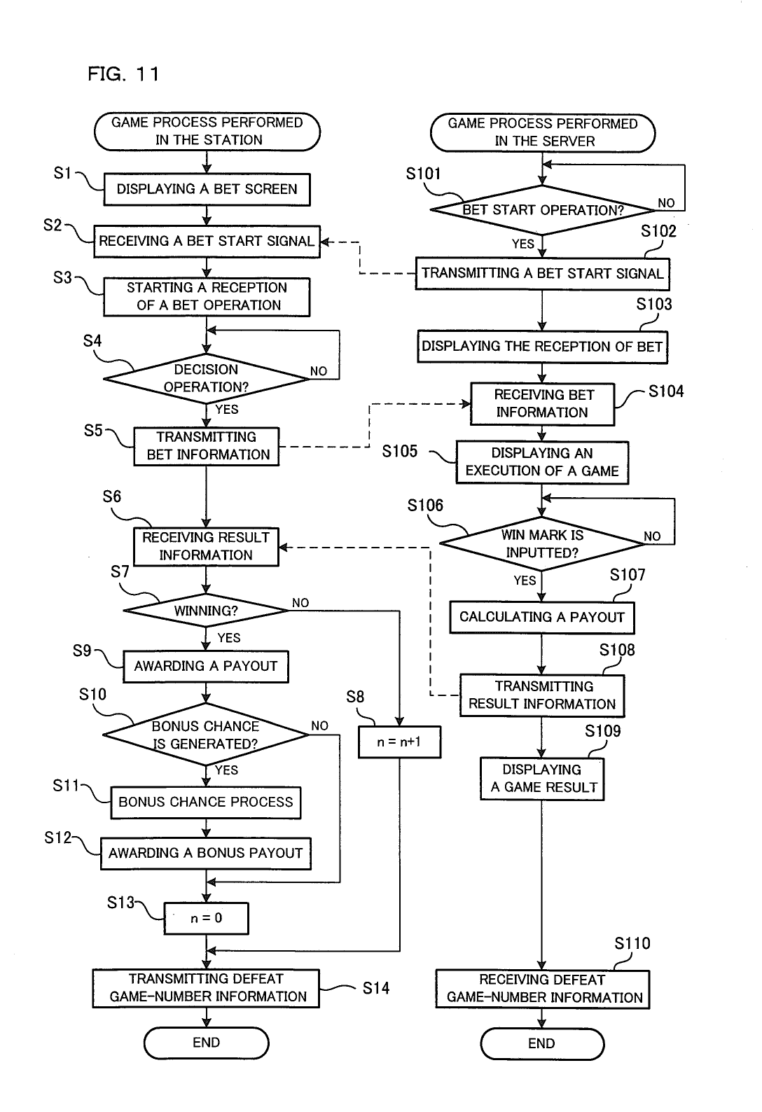

The station control CPU 91 of each station 4 executes a game process routine that is performed in the station, which is shown in FIG. 11. Firstly, as shown in FIG. 11, the station control CPU 91 displays the BET screen 20 on the liquid crystal display device 8 (S1). When a bet start signal is received from the server 80 (S2), it is started a reception of a bet operation by a player (S3). Then, it is determined whether the bet decision button 28 is pushed or not (S4). When the bet decision button 28 is not pushed (S4, NO), the step of S4 is repeated, so that a wait state is made when the bet decision button 28 is pushed. When the bet decision button 28 is pushed (S4, YES), the bet information is transmitted to the server 80 (S5).

then, when the wheel 2a of the wheel device 2 is rotated by the dealer 150 and the wheel 2a is stopped to determine a win mark, the result information thereof is received from the server 80 (S6) and it is determined whether a winning is made or not (S7). When it is determined that a winning is not made (S7, NO), the defeat game-number n is increased by “1” (S8).

In the mean time, when it is determined that a winning is made (S7, YES), a payout is awarded to a player, based on the result information (S9). After that, based on the result information, it is determined whether to generate a bonus chance (S10). When it is determined to generate a bonus chance (S10, YES), the bonus chance screen 40 is displayed on the liquid crystal display device 8 and a bonus chance process of rotating and stopping the wheel 42 on which a bonus rate is displayed is executed (S11). Based on the result information, a payout is awarded to a player (S12).

In the step of S10, when it is determined not to generate a bonus chance (S10, NO) or after the step of S12, the defeat game-number is set as “0” (S13). After the step of S8 or S13, the defeat game-number information is transmitted to the server 80 (S14) and the game process routine that is performed in the station is ended.

(Game Process Performed in the Server)

The server control CPU 81 of the server 80 executes a game process routine that is performed in the server, which is shown in FIG. 11. Firstly, as shown in FIG. 11, it is determined whether the dealer 150 performs a bet start operation for the input device 16 (S101). When it is determined that a bet start operation is not performed (S101, NO), the step of S101 is repeated, so that a wait state is made until a bet start operation is performed. When it is determined that a bet start operation is performed (S101, YES), a bet start signal is transmitted to each station 4 (S102) and a display notifying that a bet is received is made on the electric light indicator 15 (S103).

Then, when the bet information is received from each station 4 (S104), a display such as effect image showing that a game is being progressed is made on the electric light indicator 15 (S105). The wheel 2a is rotated and stopped by the dealer 150 and a mark on the wheel 2a indicated by the leading end of the stopper 2b is recognized as a win mark by the dealer 150 and a player. Then, it is determined whether the dealer 150 inputs the win mark to the input device 16 (S106). When it is determined that the win mark is not inputted (S106, NO), the step of S106 is repeated, so that a wait state is made until the win mark is inputted.

When it is determined that the win mark is inputted (S106, YES), a payout is calculated using the bet information and the win mark (S107). In other words, a payout is calculated by multiplying the number of chips by the ODDS. In addition, when a bet having a bonus chance is performed and a winning is then made, a bonus payout is calculated by multiplying the number of chips by the bonus ODDS and further the bonus rate relating to the “defeat game-number.” In other words, at this time, a result of the “bonus chance,” i.e., a bonus payout amount is determined. Then, the calculated payout or result information relating to the bonus payout is transmitted to each station 4 (S108). Then, the game result is displayed on the electric light indicator 15 (S109), the information of the defeat game-number is received from each station 4 (S110) and the game process routine that is performed in the server is ended.

Like this, when a bet having a bonus chance is performed and a payout is awarded, a bonus chance of randomly determining whether to award a bonus payout is executed. Thereby, a player does not lose an interest in the main game and a bonus is provided which suppresses a decrease in the earnings of a game.

In the mean time, in the above embodiment, a result of the “bonus chance,” i.e., a bonus payout amount is determined by the server 80. However, a result of the “bonus chance,” i.e., a bonus payout amount may be determined in each station 4.

Although the above descriptions have been provided with regard to the characteristic parts so as to understand the invention more easily, the invention is not limited to the embodiment as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be easily derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

What is claimed is:

1. A gaming machine comprising:
a specific mark determining device that determines one of a plurality of marks as a specific mark;
a display that displays a plurality of bet areas each of which corresponds to at least one mark and on each of which a game value is bet;
an input device that receives, as a bet operation, a base operation and a special operation of betting the game value on any one bet area from the outside;
a bonus determining device that randomly determines whether to award a bonus payout or not; and
a controller operates:
(a1) to respectively set, as payout rates, a base rate corresponding to the base operation and a special rate corresponding to the special operation and having a rate different from the base rate, for each of the bet areas;
(a2) to bet the game value on the bet area corresponding to the bet operation that is received by the input device from the outside;
(a3) to enable the specific mark determining device to determine the specific mark;
(a4) when the specific mark and the bet area on which the game value is bet have a corresponding relation, to award a payout, based on the game value that is bet on the bet area corresponding to the specific mark and the payout rate that is set for the bet area corresponding to the specific mark and corresponds to the bet operation received by the input device from the outside;
(a5) when the bet operation received by the input device from the outside is the special operation and the payout is awarded, to enable the bonus determining device to determine whether to award the bonus payout; and
(a6) when it is determined that the bonus payout is awarded, to award the bonus payout.

2. A gaming machine comprising:
a wheel device in which a wheel having a plurality of marks disposed thereon is rotated;
a display that displays a plurality of bet areas each of which corresponds to at least one mark and on each of which a game value is bet;
an input device that receives, as a bet operation, a base operation and a special operation of betting the game value on any one bet area from the outside; and
a controller operates:
(b1) to respectively set, as payout rates, a base rate corresponding to the base operation and a special rate corresponding to the special operation and having a rate different from the base rate, for each of the bet areas;
(b2) to bet the game value on the bet area corresponding to the bet operation that is received by the input device from the outside;
(b3) to set, as a specific mark, a mark corresponding to a specific position of the wheel stopped after the rotation;
(b4) when the specific mark and the bet area on which the game value is bet have a corresponding relation, to award a payout, based on the game value that is bet on the bet area corresponding to the specific mark and the payout rate that is set for the bet area corresponding to the specific mark and corresponds to the bet operation received by the input device from the outside;
(b5) when the bet operation received by the input device from the outside is the special operation and the payout is awarded, to randomly determine whether to award a bonus payout; and
(b6) when it is determined that the bonus payout is awarded, to award the bonus payout.

3. A gaming machine comprising:
a wheel device in which a wheel having a plurality of marks disposed thereon is rotated;
a display that displays a plurality of bet areas each of which corresponds to at least one mark and on each of which a game value is bet;
an input device that receives, as a bet operation, a base operation and a special operation of betting the game value on any one bet area from the outside; and
a controller operates:
(c1) to respectively set, as payout rates, a base rate corresponding to the base operation and a special rate corresponding to the special operation and having a rate different from the base rate, for each of the bet areas, and to set a bonus payout rate for each bet area;
(c2) to bet the game value on the bet area corresponding to the bet operation that is received by the input device from the outside;
(c3) to set, as a specific mark, a mark corresponding to a specific position of the wheel stopped after the rotation;
(c4) when the specific mark and the bet area on which the game value is bet have a corresponding relation, to award a payout, based on the game value that is bet on the bet area corresponding to the specific mark and the payout rate that is set for the bet area corresponding to the specific mark and corresponds to the bet operation received by the input device from the outside;
(c5) when the bet operation received by the input device from the outside is the special operation and the payout is awarded, to randomly determine whether to award a bonus payout; and
(c6) when it is determined that the bonus payout is awarded, to award the bonus payout, based on the game value bet on the bet area corresponding to the specific mark and the bonus payout rate set for the bet area corresponding to the specific mark.

4. A gaming machine comprising:
a wheel device in which a wheel having a plurality of marks disposed thereon is rotated;
a display that displays a plurality of bet areas each of which corresponds to at least one mark and on each of which a game value is bet;
an input device that receives, as a bet operation, a base operation and a special operation of betting the game value on any one bet area from the outside; and
a controller operates:
(d1) to respectively set, as payout rates, a base rate corresponding to the base operation and a special rate corresponding to the special operation and having a rate different from the base rate, for each of the bet areas;
(d2) to bet the game value on the bet area corresponding to the bet operation that is received by the input device from the outside;
(d3) to set, as a specific mark, a mark corresponding to a specific position of the wheel stopped after the rotation;
(d4) when the specific mark and the bet area on which the game value is bet do not have a corresponding relation, to increase a count, and when the specific mark and the bet area on which the game value is bet have a corresponding relation, to reset the count and to award a payout, based on the game value that is bet on the bet area corresponding to the specific mark and the payout rate that is set for the bet area corresponding to the specific mark and corresponds to the bet operation received by the input device from the outside;
(d5) when the bet operation received by the input device from the outside is the special operation and the payout is awarded, to randomly determine whether to award a bonus payout; and
(d6) when it is determined that the bonus payout is awarded, to award the bonus payout, based on a rate corresponding to a count before the reset.

5. A gaming machine comprising:
a wheel device in which a wheel having a plurality of marks disposed thereon is rotated;
a display that displays a plurality of bet areas each of which corresponds to at least one mark and on each of which a game value is bet;
an input device that receives, as a bet operation, a base operation and a special operation of betting the game value on any one bet area from the outside; and
a controller operates:
(e1) to respectively set, as payout rates, a base rate corresponding to the base operation and a special rate corresponding to the special operation and having a rate different from the base rate, for each of the bet areas, and to set a bonus payout rate for each bet area;
(e2) to bet the game value on the bet area corresponding to the bet operation that is received by the input device from the outside;
(e3) to set, as a specific mark, a mark corresponding to a specific position of the wheel stopped after the rotation;
(e4) when the specific mark and the bet area on which the game value is bet do not have a corresponding relation, to increase a count, and when the specific mark and the bet area on which the game value is bet have a corresponding relation, to reset the count and to award a payout, based on the game value that is bet on the bet area corresponding to the specific mark and the payout rate that is set for the bet area corresponding to the specific mark and corresponds to the bet operation received by the input device from the outside;
(e5) when the bet operation received by the input device from the outside is the special operation and the payout is awarded, to randomly determine whether to award a bonus payout; and
(e6) when it is determined that the bonus payout is awarded, to award the bonus payout, based on the game value bet on the bet area corresponding to the specific mark, a bonus payout rate set for the bet area corresponding to the specific mark and a rate corresponding to a count before the reset.

6. A playing method of a gaming machine that repeatedly executes a unit game of rotating a wheel having a plurality of marks disposed thereon, the method comprising the steps of:
(f1) respectively setting, as payout rates, a base rate corresponding to a base operation that is a bet operation of betting a game value on any one bet area and a special rate corresponding to a special operation that is the bet operation and having a rate different from the base rate, for each of bet areas;
(f2) betting the game value on the bet area corresponding to the bet operation that is received from the outside;
(f3) setting, as a specific mark, a mark corresponding to a specific position of the wheel stopped after the rotation;
(f4) when the specific mark and the bet area on which the game value is bet have a corresponding relation, awarding a payout, based on the game value that is bet on the bet area corresponding to the specific mark and the payout rate that is set for the bet area corresponding to the specific mark and corresponds to the bet operation received from the outside;
(f5) when the bet operation received from the outside is the special operation and the payout is awarded, randomly determining whether to award the bonus payout; and
(f6) when it is determined that the bonus payout is awarded, awarding the bonus payout.
